(19) United States
(12) Patent Application Publication
(10) Pub. No.: US 2021/0390936 A1
(43) Pub. Date: Dec. 16, 2021

(54) KEY-SWITCH FOR A MUSIC KEYBOARD

(71) Applicant: Ariano Instruments Private Limited, Chennai (IN)

(72) Inventors: Arul Praveen Baskaran, Tiruchirapalli (IN); Swadesh Kumar Srivastava, Bangalore (IN)

(73) Assignee: Ariano Instruments Private Limited, Chennai (IN)

(21) Appl. No.: 17/311,158

(22) PCT Filed: Dec. 6, 2019
(86) PCT No.: PCT/IB2019/060512

§ 371 Date: Jun. 4, 2021

(30) Foreign Application Priority Data
Dec. 7, 2018 (IN) 201841046473

(51) Int. Cl. G10H 1/34; G10C 3/12

(52) U.S. Cl. CPC G10H 1/344; G10H 2220/281; G10H 2220/221; G10C 3/12

(57) ABSTRACT

An improved musical instrument is disclosed. The musical instrument includes at least one key assembly and at least two sets of sensors. The sensors sense one or more attributes pertaining to a force exerted on the at least one key assembly. A control unit is provided to determine amount of force sensed by sensors based on the sensed one or more attributes, and to determine location, at which the force on the at least one key assembly is exerted based on the determined amount of force sensed by the sensors. The control unit is configured to generated signals based on the determined amount of force sensed by the sensors, and the determined location. The generated signals are associated with one or more acoustic parameters.

### TECHNICAL FIELD

The present disclosure relates to field of electronic musical instruments. More specifically, it pertains to a keyboard in the musical instrument, specifically to key-switch employed in the keyboard of the musical instrument.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

Music and musical instruments have been in existence since almost pre-historic times. Early flutes made from animal bones have been found to be at least 37,000 years old while oldest known written songs date to about 4,000 years ago.

A myriad of musical instruments now exists. Many of such instruments—for instance, flute, guitar etc. provide for completely analogous inputs (as achieved by controlled breathing into a flute or bending a guitar wire etc.). As per interaction with a player, such a musical instrument plays sounds accordingly. Smooth changes in tones etc. can be achieved.

As with any other field, music and musical instruments such as keyboard have also evolved to take advantage of digital technologies and many digital keyboards exist. However, present music keyboards allow very less direct continuous control of the notes/sounds played on them, due to the relatively binary nature of data acquisition. Such digital systems detect only if a key is depressed or not and additionally the velocity during the impact. There are no easily implementable means whereby the much finer nuances of creating music—as are possible using analogue instruments—can be enabled on digital keyboards.

While many attempts have been made to create digital keyboards that can also capture the finer nuances of music playing as is possible on analogue instruments, they have some disadvantages. For instance, such keyboards are either too expensive to build due to complex circuitry and large number of components, or compromise on the tactile ‘click’ type interface that is an essential part of learning a keyboard and without which the keyboard is very hard to learn. Further, latency (that is, time interval between when a key is hit and when corresponding sound is generated) is higher when more components are involved. Reducing latency can lead to a better keyboard.

Hence there is a need in the art for a device that can accept continuously variable analogue inputs (as may be generated by nuanced actions/gestures such as varying force of breathing into a flute or bending a guitar's wire or very quickly moving a tone bar up and down a string of a Hawaiian guitar to create a tremolo effect etc.) and create appropriate analogue outputs to drive other circuits of a digital keyboard and thereby capture all the finer nuances of playing an analogues musical instrument. The device should be easy and economical to manufacture, and easy to adapt to existing music keyboards. At the same time, the device should provide for tactical response essential in learning a music keyboard and allow for conventional key-based interactions.

In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

### OBJECTS OF THE INVENTION

A general object of the present disclosure is to provide an improved electronic musical instrument with more nuance gestures.

An object of the present disclosure is to provide a simple electronic musical instrument with a minimal number of sensors.

Another object of the present disclosure is to provide an improved electronic musical instrument that is economical to manufacture, and easy to capture all the finer nuances of playing an analogues musical instrument.

Another object of the present disclosure is to provide a musical instrument with more continuous expressive music control to its user/performer required for producing various expressive instrumental sounds than offered by a traditional electronic Musical Instrument Digital Interface (MIDI) keyboard.

These and other objects of the present invention will become readily apparent from the following detailed description taken in conjunction with the accompanying drawings.

### SUMMARY

The present disclosure relates to electronic musical instruments. More specifically, it pertains to a keyboard in the musical instrument, specifically to key-switch employed in the keyboard of the musical instrument.

In an aspect, the present disclosure provides a musical instrument includes at least one key assembly. The at least one key assembly can include at least two members comprising a first member and a second member. The first member is movably configured with respect to the second member along an axis to move between a pushed position in which the first member is moved towards the second member, and a raised position in which the first member is moved away from the second member. The at least one key assembly includes a plunger that is configured between the first member and the second member such that when a force is exerted on top surface of the first member, the plunger gets compressed to allow the first member to move from the raised position to the pushed position. The removal of the force from the plunger in the compressed state enables the first member to move from the pushed position to the raised position, the force being transferred from the first member to the second member through the plunger. The musical instrument includes at least two sets of sensors coupled to the second member at predefined positions to sense one or more attributes pertaining to the force exerted on the first member; and a control unit operatively coupled to the at least two sets of sensors. The control unit configured to determine an amount of force sensed by each of the at least two sets of sensors based on the sensed one or more attributes, and determine a location, at which the force on the first member is exerted, based on the determined amount of force sensed by each of the at least two sets of sensors. The control unit is configured to generate signals based on the determined amount of force sensed by each of the at least two sets of sensors, and the determined location. The generated signals are associated with one or more acoustic parameters.

In an embodiment, the axis along which the first member is movably configured with respect to the second member is perpendicular to the first member and the second member.

In an embodiment, the at least two sets of sensors can include a first set of sensors and a second set of sensors.

In an embodiment, the first set of sensors is configured to sense one or more attributes pertaining to a first amount of the force and the second set of sensors is configured to sense one or more attributes pertaining to a second amount of the force, where the first amount of the force and the second amount of the force together amounts to the force exerted on the first member.

In an embodiment, the first set of sensors and the second set of sensors can be connected to a top surface of the second member at opposite ends.

In an embodiment, the first set of sensors and the second set of sensors are connected to a bottom surface of the second member at opposite ends.

In an embodiment, the one or more attributes pertaining to the force comprises at least one of a velocity at which the force is exerted, an angle at which the force is exerted, and a pressure exerted by the force.

In an embodiment, the one or more acoustic parameters comprises at least one of note, pitch bend, velocity, slide modulation, and pitch.

In another aspect, the present disclosure provides a method for building a musical instrument. The method includes providing, at least one key assembly and at least two sets of sensors; sensing, by the at least two sets of sensors, one or more attributes pertaining to the force exerted on the at least one key assembly; determining, by one or more processors of a control unit of the instrument, an amount of force sensed by each of the at least two sets of sensors based on the sensed one or more attributes; determining, by the one or more processors, a location, at which the force on the at least one key assembly is exerted, based on the determined amount of force sensed by each of the at least two sets of sensors; and generating, by the one or more processors, signals based on the determined amount of force sensed by each of the at least two sets of sensors, and the determined location. The generated signals are associated with one or more acoustic parameters.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an exemplary representation of the proposed musical instrument, in accordance with an embodiment of the present disclosure.

FIGS. 2A to 2C illustrate exemplary representations of a top view, side view and a bottom view of a long (white) key assembly, respectively, of the proposed musical instrument, in accordance with embodiments of the present disclosure.

FIGS. 3A to 3C illustrate exemplary representations of a top view, side view and a bottom view of a short (black) key assembly, respectively, of the proposed musical instrument, in accordance with embodiments of the present disclosure.

FIGS. 4A to 4B illustrate exemplary representation of a key assembly with fixed end without and with application of a force, respectively, of the proposed musical instrument, in accordance with an embodiment of the present disclosure.

FIGS. 5A and 5B illustrate exemplary representation of a key assembly with a projected member without and with application of a force, respectively, of the proposed musical instrument, in accordance with an embodiment of the present disclosure.

FIG. 6 illustrates an exemplary representation of an arrangement beneath key-assembly when arranged in the proposed musical instrument, in accordance with an embodiment of the present disclosure.

FIG. 7 illustrates an exemplary representation of the proposed musical instrument with an arrangement of sensors, in accordance with an exemplary embodiment of the present disclosure.

FIGS. 8A to 8C illustrate exemplary representations of a short key assembly and a long key assembly with extended second member, in accordance with embodiments of the present disclosure.

FIGS. 9A to 9C illustrate exemplary representations of a top view, side view, and a bottom view of a key assembly with an arrangement of sensors, of the proposed musical instrument, in accordance with embodiments of the present disclosure.

FIGS. 10A to 10C illustrate exemplary representations of a top view, side view, and a bottom view of a key assembly with two plunger mechanisms, of the proposed musical instrument, in accordance with embodiments of the present disclosure.

FIGS. 11A to 11C illustrate exemplary representations of a top view, side view, and a bottom view of a key assembly with an angular plunger mechanism of the proposed musical instrument, in accordance with embodiments of the present disclosure.

FIGS. 12A and 12B illustrate exemplary representations of a key assembly with an extended hinge employed and a biasing element with and without application of a force, in accordance with an embodiment of the present disclosure.

FIGS. 13A and 13B illustrate exemplary representations of a key assembly with an extended hinge with and without application of a force, in accordance with an embodiment of the present disclosure.

FIGS. 14A and 14B illustrate exemplary representations of working of a key assembly of the proposed musical instrument, in accordance with an embodiment of the present disclosure.

FIG. 15 illustrates a flow diagram of a method for building a musical instrument, in accordance with an embodiment of the present disclosure.

### DETAILED DESCRIPTION

The following is a detailed description of embodiments of the disclosure depicted in the accompanying drawings. The embodiments are in such details as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

If the specification states a component or feature “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Various terms as used herein are shown below. To the extent a term used in a claim is not defined below, it should be given the broadest definition persons in the pertinent art have given that term as reflected in printed publications and issued patents at the time of filing.

The present disclosure relates to electronic musical instruments. More specifically, it pertains to a keyboard in the musical instrument, specifically to key-switch employed in the keyboard of the musical instrument.

FIG. 1 illustrates an exemplary representation of the proposed musical instrument 100, in accordance with an embodiment of the present disclosure. As illustrated in FIG. 1, the proposed musical instrument (interchangeably referred as system or instrument) may include at least one key assembly such as long key assemblies (also referred to as white key assembly hereinafter) 102 and short key assemblies (also referred to as black key assembly) 104 fitted in a chassis 106 of the proposed musical instrument 100.

In an exemplary embodiment, the short key assembly 104 may be envisioned as a rectangle. However, the key assembly 102/104 may be of any suitable shape.

The short key assemblies 104 are interspersed in the long key assemblies 102.

In an embodiment, the key assemblies 102/104 are mechanical key assemblies designed for implementation in the proposed musical instrument 100 to provide more continuous expressive music control to its user/performer than offered by a traditional electronic Musical Instrument Digital Interface (MIDI) keyboard.

In another aspect, the key assemblies 102/104 (interchangeably termed as key-switch) may detect a force exerted by a finger as well as change in exerted force, and a location, where the finger pressure is placed to exert the force. This may enable a performer to produce vibratos, pitch bending and other note shaping effects with a very natural and intuitive finger motions while such notes are still sustained.

In the instrument 100, tactile feedback is important for learning as well as expert performance.

In another aspect, each key assembly 102/104 in the proposed musical instrument 100 may include three main components—a first member, a second member and a plunger/movement means/mechanism configured between the first member and the second member to enable the key action. Particularly, when a force is exerted on a top surface of the first member in a raised position, the force is transferred to the second member through the plunger, thereby enabling the first member to move in the pushed position. Similarly, when the force is removed from the first member in the compressed state, the first member may move from the pushed position to the raised position i.e. away from the second member.

In an embodiment, a plunger may be configured between the first member and the second member such that when a force is exerted on the top surface of the first member, the plunger gets compressed to allow the first member to move from the raised position to the pushed position. The force exerted on the first member is transferred to the second member through the plunger. On removal of the force from the plunger in the compressed state, the compressed plunger enables the first member to move from the pushed position to the raised position.

In an embodiment, two (or more) sets of sensors may be coupled beneath the second member using any suitable means, such as an adhesive on edges of the second member. Each sensor may be an electrical matrix of one or more force transducers, configured to generate an electric signal proportional to the force sensed by them. The transducers may be resistive, capacitive, optical or may be using any other similar means to perform force sensing when exposed to a corresponding mechanical stress.

As elaborated, when a force is applied on the first member, the force may be transferred to the second member through plunger/plunger mechanism and accordingly to the sensors beneath the second member. Since the sensors may be configured on edges of the second member, each sensor may record uneven amount of forces of the exerted force, together adding up to the total force exerted on the first member. In an exemplary embodiment, the sensor on the ‘top’ edge of the key assembly of the proposed instrument 100 may have only one transducer, while that on the ‘bottom’ edge of the key assembly of the proposed instrument 100 may have two force transducers.

In an embodiment, as a finger moves over the first member i.e. a location, where the force is exerted, is changed, distribution of forces on the first member may vary and accordingly a centre of pressure (COP) or centre of force on the first member. This uneven distribution of forces may be used ultimately to generate variations in electric signals that may correspond to the nuanced actions/gestures/movements made by the finger on the first member. The electric signals may in turn be used to drive other circuits of the musical instrument and generate sound variations accordingly.

In this manner, whenever the key assembly as described herein is pressed, corresponding musical note/tone may be realised. Changes in amount of the force exerted by a finger and location where the force is exerted on the key assembly may be tracked as elaborated above and signals so generated may be communicated to any sound synthesis technique through protocols like MIDI to produce the intended sound modulation. In this manner, a performer may produce various sound effects such as vibratos, pitch bending and other note shaping effects with a very natural and intuitive finger motions while such notes are still sustained.

In an embodiment, the proposed musical instrument 100 may include a control unit that may be attached to the array of the sensors. The control unit may receive one or more attributes as input parameter and generate one or more signals. In another embodiment, the control unit may determine one or more parameters such as but not limited to the location of the force exerted on the key assembly and amount of exerted force. The control unit may then generate one or more signals based on the determined parameters as described above.

In an embodiment, the proposed musical instrument 100 may include a sound generating unit (also referred to as tone generator) operatively coupled with the control unit.

The sound generating unit may receive the generated signal as input parameter and generate sound/musical tone as output. In some exemplary embodiments, the sound generating unit may include, by way of example, but not limited to one or more audio amplifiers and speakers.

It would be appreciated that units being described are only exemplary units and any other unit or sub-unit may be included as part of the proposed musical instrument 100. These units too may be merged or divided into super-units or sub-units as may be configured. The control unit or the sound generating unit may be implemented as a hardware component. In different embodiments, the control unit or the sound generating unit may be implemented as a computer program product, which may include a computer-readable storage medium employing a set of instructions.

A person skilled in the art will appreciate that the proposed musical instrument 100 may also include one or more units to produce or synthesize a particular musical tone, for instance it may be computerized music arranger, audio amplifier, speakers and so forth.

In an exemplary embodiment, the instrument 100 may be configured as different musical instruments such as but not limited to acoustic piano, harpsichord, a pipe organ, and so forth. A plurality of key assembly as described above may be configured together to form a music keyboard similar to, for instance, the layout of a piano keyboard. White and black key-switches as in a piano keyboard may be configured. As further elaborated, in this manner, three rows of sensors may be formed wherein the top row may be formed by sensors/sensors in all key-switches, the middle row may be formed by sensors on the bottom edge of the black keys, while the bottom row may be formed by sensors configured on bottom edge of the white keys. Outputs from all such arrays may be ultimately provided to a controller (can also be referred to as a control unit) and further converted into sounds.

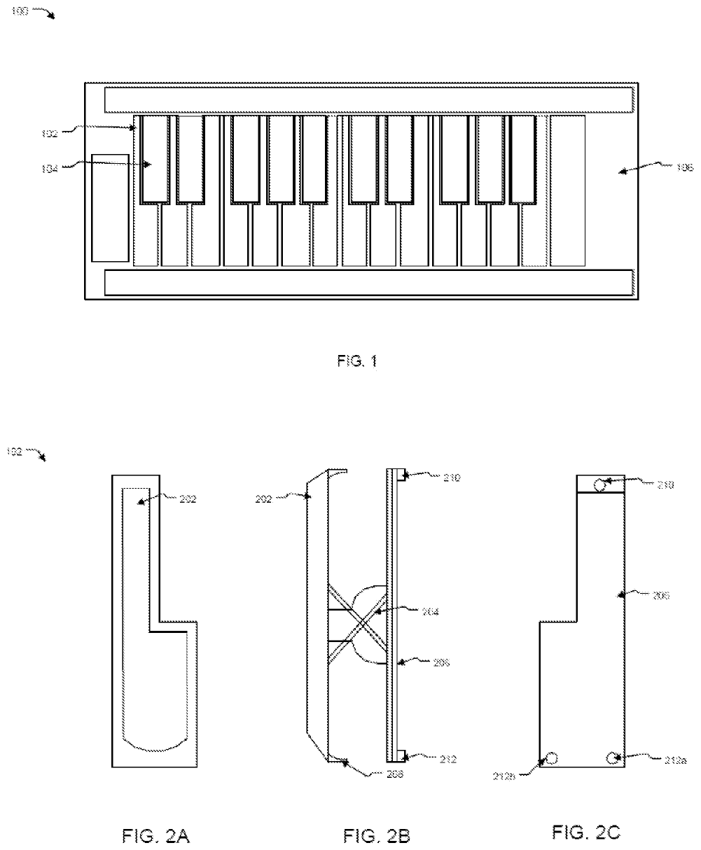

FIGS. 2A to 2C illustrate exemplary representations of a top view, side view and a bottom view of a long (white) key assembly, respectively, of the proposed musical instrument, in accordance with embodiments of the present disclosure.

In an embodiment, a long key assembly 102 (white key assembly) of the proposed instrument 100 may include a first member 202 (also referred to as white first member 202), a plunger 204 and a second member 206. It may be readily understood that a short key assembly (also referred to as a black key assembly) may be similarly constructed with similar components.

FIG. 2A depicts a top view of the long key assembly 102 showing a first member 202, FIG. 2B depicts a side view of the long key assembly 102. In an embodiment, the long key assembly 102 may include at least two members including the first member 202 and the second member 206. The first member 202 is movably configured with respect to the second member 206 along an axis to move between a pushed position in which the first member 202 is moved towards the second member 206, and a raised position in which the first member 202 is moved away from the second member 206. The axis along which the first member 202 is movably configured with respect to the second member 206 is perpendicular to the first member 202 and the second member 206.

In an embodiment, the plunger 204 is configured between the first member 202 and the second member 206 to allow the first member 202 to move between the raised position and the pushed position. When a force is exerted on the top surface of the first member 202 the plunger 204 gets compressed to allow the first member 202 to move from the raised position to the pushed position that is closer to the second member 206. On removal of the exerted force from first member 202 that is from the plunger 204 in the compressed state, the compressed plunger 204 enables the first member 202 to move from the pushed position to the raised position. The force being transferred to the second member 206 through the plunger 204.

In an embodiment, bushes 208 may be provided at two opposite ends of the first member 202 and projecting towards the second member 206 to enable the first member 102 to structurally couple to the second member 206 when the key assembly 102 is depressed to its limit by a human performer (scenario not shown here), and thereby providing the force distribution to the second member 206, while stopping further travel of first member 202 towards the second member 206.

In an embodiment, at least two sets of sensors (interchangeably termed as sets of pressure sensors hereinafter) may be adhesively coupled to a base of the second member 206 at predefined positions. For an instance, the at least two set of sensors may include a first set of sensors 210 and a second set of sensors 212. In an embodiment, the first set of sensors 210 and the second set of sensors 212 may be coupled to opposite ends of a bottom surface of the second member 206. In another embodiment, the first set of sensors 210 and the second set of sensors 212 may be coupled to opposite ends of a top surface of the second member 206. In an embodiment, each of the first set of sensors 210 and a second set of sensors 212 may include one or more sensors that may pertain to any or a combination of a force, torque, pressure and so forth.

In an exemplary embodiment, the first 210 and second 212 sets of sensors may be configured to sense one or more attributes pertaining to the force exerted on the first member 202. Specifically, the first set of sensors 210 may be configured to sense a first amount of the exerted force. The second set of sensors 212 may be configured to sense a second amount of the exerted force. A cumulative value of the first amount of force and the second amount of the force may be the total force exerted on the first member 202.

In an embodiment, the one or more attributes may include, by way of example but not limited to, any or a combination of pressure and torque.

FIG. 2C depicts the bottom view of the key assembly 102 showing an arrangement of the two sets of force sensors 210 and 212. In an exemplary embodiment, the first set of sensors 210 may include at least one sensor. The second set of sensors may include at least two sensors 212a and 212b. As may be understood, depressing one side of the first member 102 may exert more pressure on a sensor (say 212a) the corresponding side of the second member 206, and less on a sensor (say 212b) on other side the second member 206.

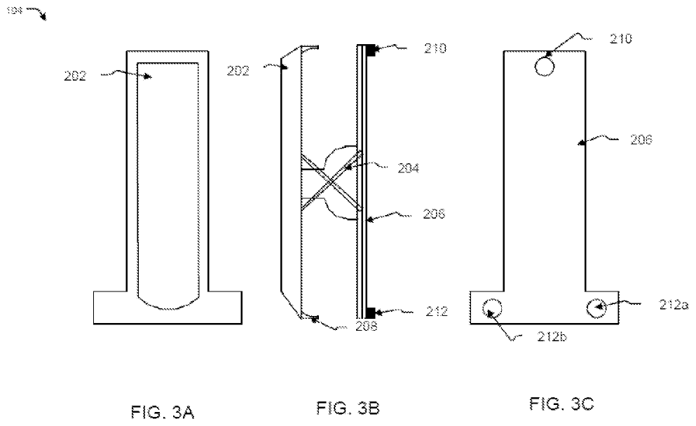

FIGS. 3A to 3C illustrate exemplary representations of a top view, side view and a bottom view of a short (black) key assembly, respectively, of the proposed musical instrument, in accordance with embodiments of the present disclosure. As shown, the short black key assembly 104 (also referred to as short a black key assembly 104) can include a black first member 302 (also referred to as a black first member 302), a plunger mechanism 304 and corresponding a second member 306 (also referred to as a black second member 302).

FIG. 3A showing the first member 202 of the key assembly 104. FIG. 3B depicts a side view of the key assembly 104 particularly showing the plunger mechanism 204 configured between the first member 202 and the second member 206. Similar to the long key assembly, bushes 208 may be configured on the first member 202 to facilitate distribution of a force exerted on the first member 202 to the second member 208.

In an embodiment, at least two sets of sensors (e.g. sets of pressure sensors) may be adhesively coupled to an upper/top surface of the second member 206 at predefined positions i.e. opposite ends of the second member. In another embodiment, the at least two sets of sensors may be adhesively coupled to bottom/lower surface of the second member 206 at predefined positions i.e. opposite ends of the second member. For an instance, at least two sets of sensors can include a first set of sensors 210 and a second set of sensors 212 that may be coupled to the opposite ends of the second member 206. The second member 206 may be supported on the chassis (not shown) of the proposed instrument 100.

In an exemplary embodiment, the first 210 and second 212 sets of sensors may be configured to sense one or more attributes pertaining to the force exerted on the first member 202. Specifically, the first set of sensors may be configured to sense a first amount of the force exerted and the second set of sensors may be configured to sense a second amount of the force exerted. The first amount and the second amount of the force may collectively contribute to the total force exerted on the first member 202.

FIG.3C depicts the bottom view of the key assembly 104 showing an arrangement of the two sets of force sensors. In an exemplary embodiment, the first set of sensors 210 may include one sensor. The second set of sensors 212 may include at least two sensors 212a and 212b. As may be understood, depressing one side of the first member 202 may exert more pressure on a sensor (say 212a) on a side of the second member, and less on a sensor (say 212b) on other side of the second member.

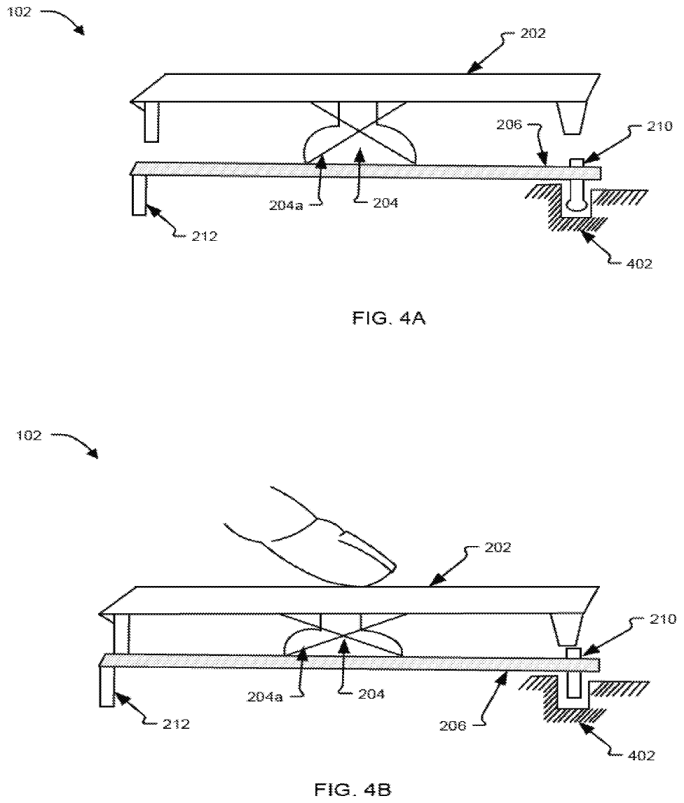

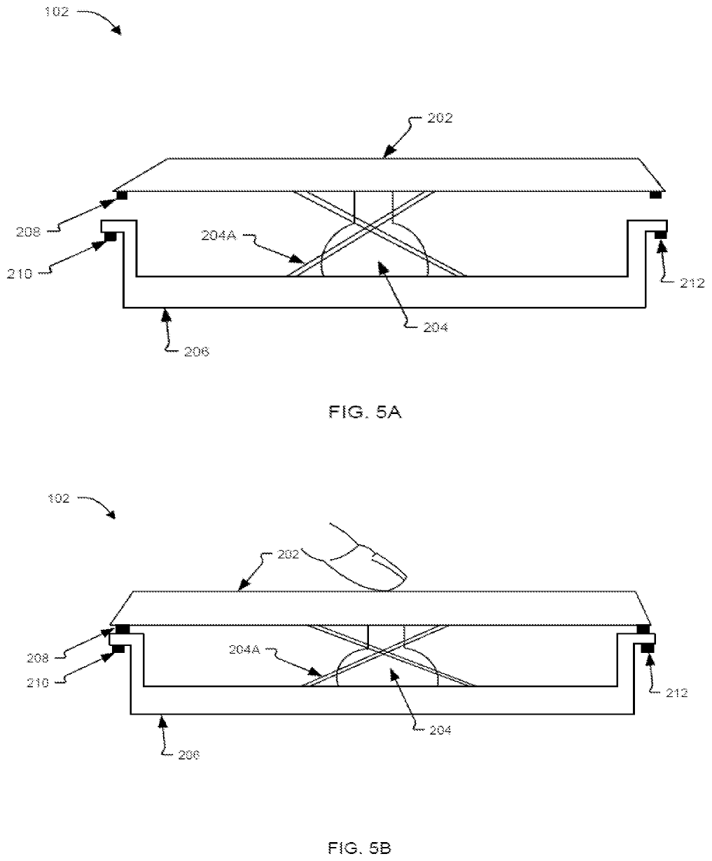

FIGS. 4A to 4B illustrate exemplary representation of a key assembly with fixed end without and with application of a force, respectively, of the proposed musical instrument, in accordance with embodiments of the present disclosure. The key assembly 102 may include a first member 202, the second member 206, and a plunger mechanism 204 being configured between the first member 202 and the second member 206.

As earlier described, the sensor 210 and 212 may be attached to the second member 206 of the key assembly through an adhesive means. Additionally or alternatively, some ends of key assembly may be fixed and may provide a sensing provision 210 above the second member. As shown in FIGS. 4A and 4B, one end of the second member 206 may be fixed to a surface 402. In another embodiment, more than one end of the second member 206 may be fixed to the surface. The surface 402 can be the chassis of the musical instrument 100.

In an embodiment, the plunger mechanism 204 may include a stabilizing mechanism 204a to prevent any undesired wobble motions on the key assembly 102.

In an embodiment, while transferring force exerted on the first member 202 to the second member 206 through the plunger 204, bushes 208 may be provided to enable a structural coupling between the first member 202 and the second member 206 when the key assembly 102 is depressed by a human performer to its limit (see FIG. 4B).

FIGS. 5A and 5B illustrate exemplary representation of a key assembly with a projected member without and with application of a force, respectively, of the proposed musical instrument, in accordance with an embodiment of the present disclosure. In an embodiment, the key assembly 102 includes a second member having at least two projections located at two opposite ends of the second member 206, a first member 202 and a plunger 204, as shown in FIG. 5A and 5B. The projections of the second member 206 are configured to support the first member 202 when the first member is moved to the pushed position. Bushes 208 of the first member 202 rest on the projects of the second member 206 when the first member moved to the pushed position when the force is applied on the first member 202 (shown in FIG. 5B).

As shown in FIGS. 4A to 5B, the second member 206 of the key assembly may be fixed at one end or the second member 206 may include projections at opposite ends. However, other possibility of the second member may also be possible depending upon the requirement, that would be appreciated by the person skilled in the art.

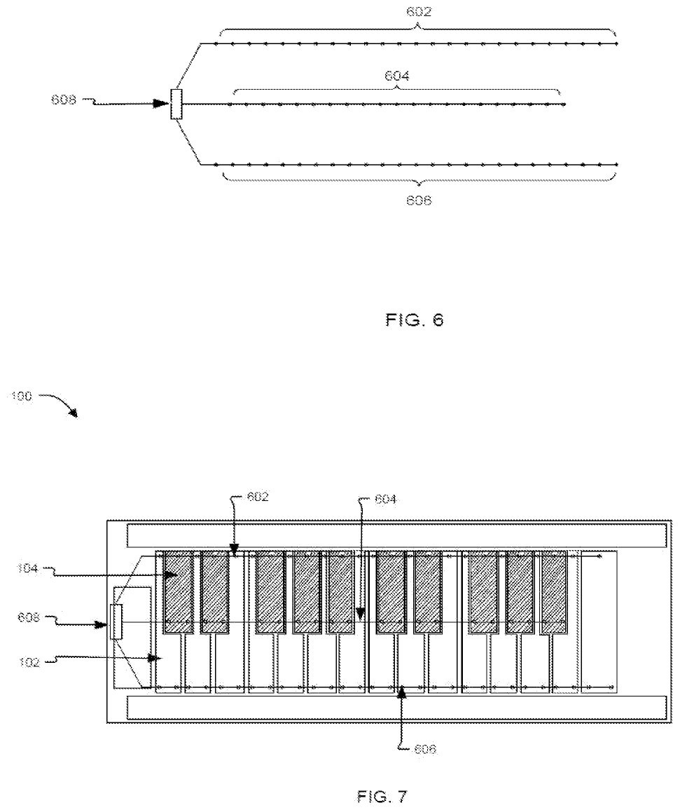

FIG. 6 illustrates an exemplary representation of an arrangement of at least two set of sensors of a key-assembly in the proposed musical instrument, in accordance with an embodiment of the present disclosure.

As the key assemblies 102/104 are arranged side-by-side as in the proposed instrument 100, the set of sensors beneath the second members 206 of the key assemblies 102/104 may align with each other as shown in FIG. 6. For an instance, various sensors may be arranged in three rows shown as rows 602 (upper), 604 (middle) and 606 (lower) respectively. In an embodiment, the row 602 may have all the sensors of the key assemblies102 and 104 located at one end of the second member 206.

In an embodiment, the middle row 604 may have sensors located at another end of second members 206 of the short key assemblies 104.

In an embodiment, the bottom row 606 may have sensors located at other end of the second members 206 of the long key assemblies 102.

In an embodiment, the sensors are configured to sense one or more attributes pertaining to the force exerted on the key assemblies 102/104. Output from the various sensors may be provided to a controller 608. Based on the received output from the sensors, the controller 608 can be configured to generate signals that are associated with one or more acoustic parameters.

In an embodiment, the acoustic parameters may include one or more of note, pitch bend, velocity, slide modulation, and so forth.

Referring to FIG. 7, where the proposed musical instrument with long key assemblies 102, short key assemblies 104, an arrangement of sensors of the key assemblies 102/104 and a controller 608 is shown, in accordance with an exemplary embodiment of the present disclosure.

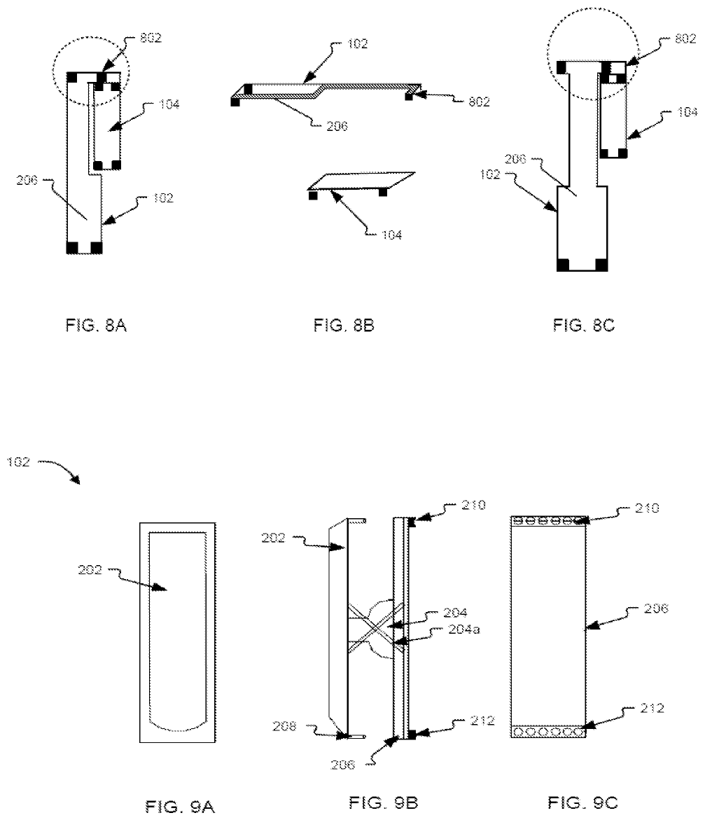

FIGS. 8A to 8C illustrate exemplary representations of the short key assembly and the long key assembly with extended second member, in accordance with an exemplary embodiment of the present disclosure. In an embodiment, in the arrangement of the long key assembly 102 can include a second member 206 having a generally L-shaped extended portion 802 at one end that is farther end. In an embodiment, the second member 206 having a generally T-shaped extended portion 802 at the farther end. The second member 206 with the extended portion 802 can be adapted to accommodate the keys in a linear or nonlinear fashion.

FIGS. 9A to 9C illustrate an exemplary representation of a top view, side view, and a bottom view of a key assembly with an arrangement of sensors, in accordance with an embodiment of the present disclosure. FIG. 9A illustrates a top view of a key assembly 102 showing a first member 202. Size and form factor of the first member 202 may be selected as per the requirement. For instance, the first member 202 may be long or short, thin or thick, heavy or light etc.

As illustrated in FIG. 9B, a plunger mechanism 204 may be configured between the first member 202 and the second member 206. The plunger mechanism 204 may also include a stabilizing mechanism 204a to prevent any undesired wobble motions on the key assembly.

In an embodiment, while transferring force exerted on the first member 202 to the second member 206 through the plunger 204, bushes 208 may be provided to serve primarily to enable a structural coupling between the first member 202 and the second member 206 when the key assembly is depressed by a human performer to its limit (scenario not shown).

FIG. 9C illustrates a bottom view of a second member 206, showing possible rows of sensors 210 and 212 located at opposite ends of the second member 206. In an exemplary embodiment, each row includes one or more sensors. This may enable implementation of a preferred embodiment that at least three sensors need to be placed in a non-linear alignment in order to discern location and total pressure values generated by a finger moving on the first member 202.

In an embodiment, any number of plunger mechanism designs may be implemented in the above assembly, as further elaborated. More than one plunger may be employed to distribute force/load applied on the first member to the edges of the second member. Bushes may be configured beneath the first member to stop further downward travel of the first member when required and still transfer the force to the second member.

FIGS. 10A to 10C illustrate an exemplary representation of top view, side view, and bottom view of a key assembly with two plunger mechanisms, in accordance with an embodiment of the present disclosure. As illustrated, the key assembly 102 is employed with multiple plunger mechanisms 204-1 and 204-2, which may be used to provide more stability and uniform travel of a first member 202 of the key assembly 102 with respect to a second member 206, while also enabling a better distribution of forces to the second member 206 of the key assembly 102.

FIG. 10A illustrates a top view of the key assembly 102 showing the first member 202 that could be of any dimension and shape.

FIG. 10B illustrates a side view of the key assembly 102 showing two plunger mechanisms 204-1 and 204-2 (collectively termed as 204). Each plunger mechanism may have their respective stabilizing mechanisms 204a to guide the key action with a stable key press.

FIG. 10C illustrates a bottom view of the key assembly 102, exposing possible arrangement of sensors having two rows of sensors adhesively coupled to a bottom surface of the second member 206 to sense force distribution values when the first member 202 is pressed.

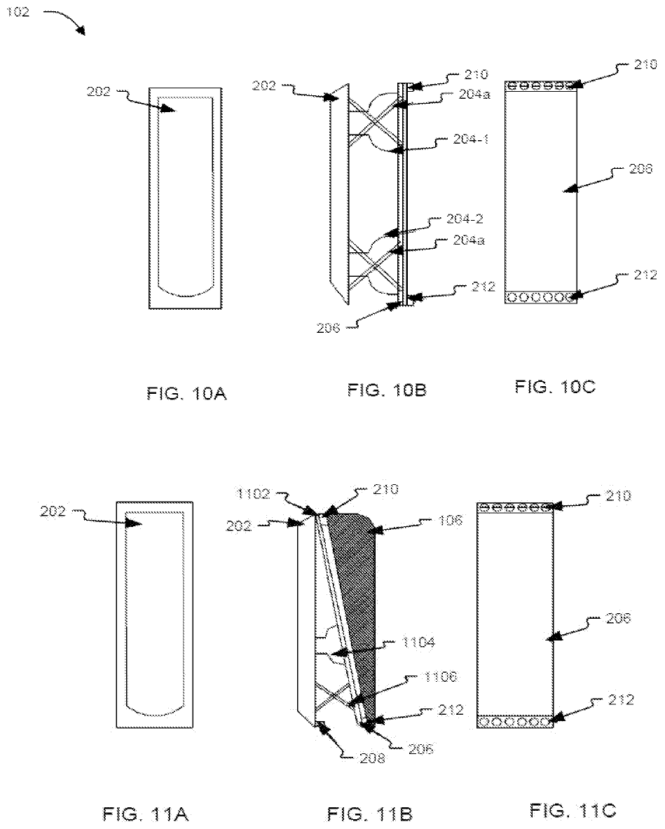

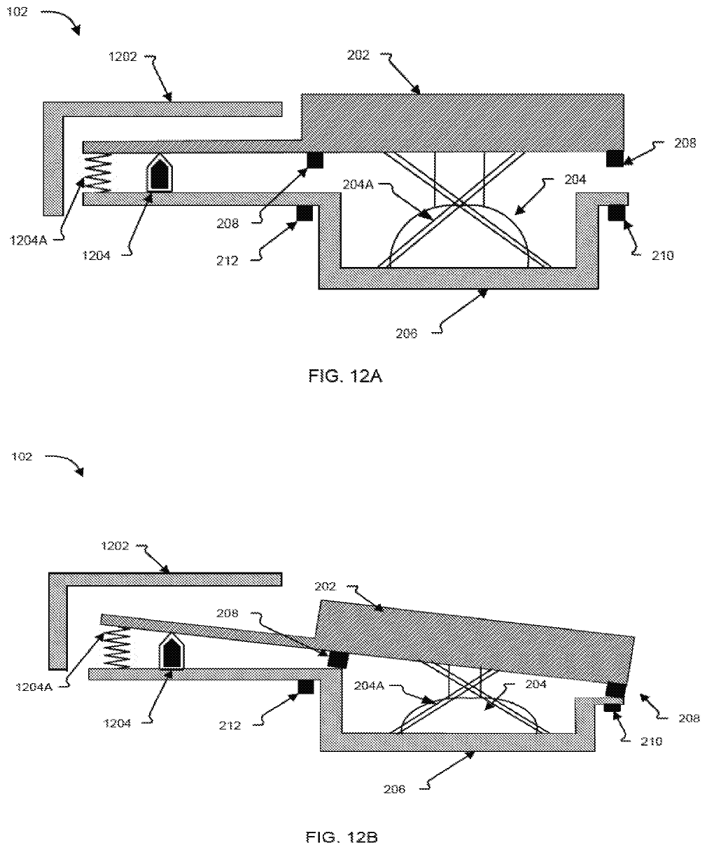

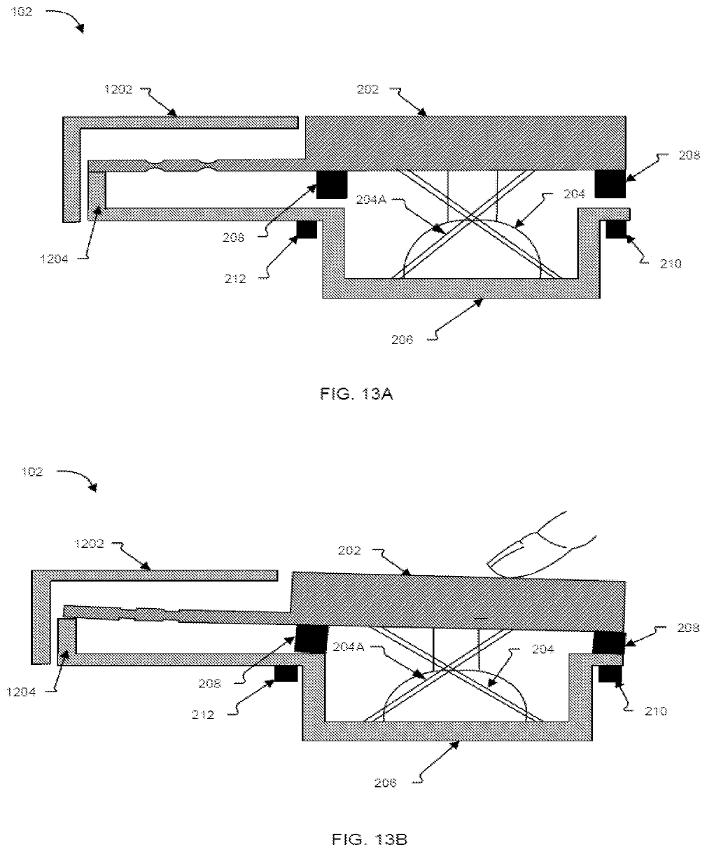

FIGS. 11A to 11C illustrate exemplary representations of top view, side view, and bottom view of key assembly 1100 with an angular plunger mechanism, in accordance with an embodiment of the present disclosure.

FIG. 11A illustrates a top view of the key assembly 102 showing the first member 202, similar to as already described. The first member 202 may be employed with bushes 208.

FIG. 11B illustrates a side view of the key assembly 102 showing arrangement of its different components. In an embodiment, the plunger 204 can be an angular plunger mechanism that is fitted between the first member 202 and the second member 206. In an embodiment, the angular plunger mechanism 204 may include three components: a hinge 1102, plunging means 1104 and stabilizing means 1106. The hinge 1102 may pivot the first member 202 about one edge of the second member 206, facilitates an angular key motion. The plunging means 1104 may be provided for elastic key retaliation of the first member 202 and offer resistance to depression of the key assembly 102 (similar retaliation and resistance may be offered by other plunger mechanisms already described). The stabilizing means 1106 may assist in stable key-action. The bushes 208 may transfer force from the first member 202 to the second member 206 when the first member 202 is pressed to its limit.

In an embodiment, the first and second sets of sensors 210 and 212 (that may be arrays of sensors as shown) may be placed on a bottom surface of the second member 206. The key assembly 102 may be attached to a chassis 106 of the proposed instrument in such a manner that the first and the second sets of sensors 210 and 212 are in contact with the chassis 106 and force exerted on the first member 202 is transferred to chassis 106 via the sensors.

FIG. 11C shows a bottom view of the key assembly 102, exposing possible arrangement of the first and the second set of sensors 210 and 212 adhesively coupled to the bottom surface of the second member 206.

FIGS. 12A and 12B illustrate exemplary representations of a key assembly 102 with an extended hinge employed and a biasing element with and without application of a force, in accordance with an embodiment of the present disclosure.

In an embodiment, as shown in FIGS. 12A and 12B, the key assembly 102 may be provided with an extended hinge 1202. The key assembly 102 may include a first member 202, a second member 206, sensors 210 and 212, a plunger 204, and a hinge 1204. The key assembly 102 may also include a biasing element 1204a such as but not limited to a spring. The plunger 204 may include a stabilizing mechanism 204a to prevent any undesired wobble motions on the key assembly 102.

In an embodiment, the extended hinge 1202 may restrict the movement of the first member 202, as shown in FIG. 12. The movement of the first member 202 may facilitate the first member 202 to rotate about the extended hinge 1202. The rotation of the first member 202 may enable the first member 202 to be in contact with the second member 206.

FIGS. 13A and 13B illustrate exemplary representation of key assembly 102 with an extended hinge 1202 with and without application force, in accordance with an embodiment of the present disclosure. The key assembly 102 can be implemented without the biasing element 1204a (as shown in FIG. 13). The plunger 204 may include a stabilizing mechanism 204a to prevent any undesired wobble motions on the key assembly 102.

In an embodiment, the first member 206 may be configured to rotate about the extended hinge 1202 which may enable bushes 208 to be in contact with the second member 206. The rest of the mechanism of the key assembly may be similar to the key assembly 102 shown in FIGS. 12A and 12B.

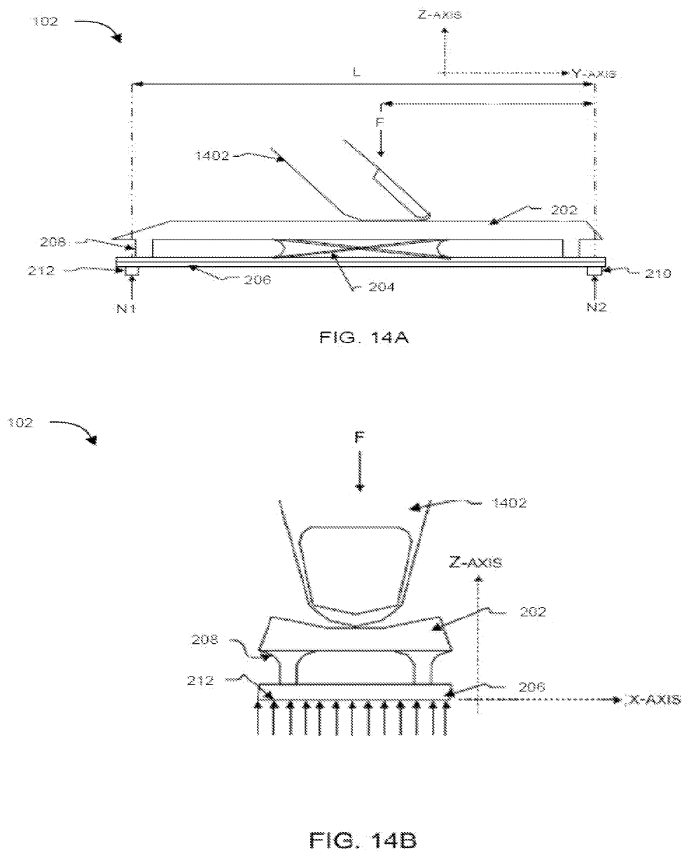

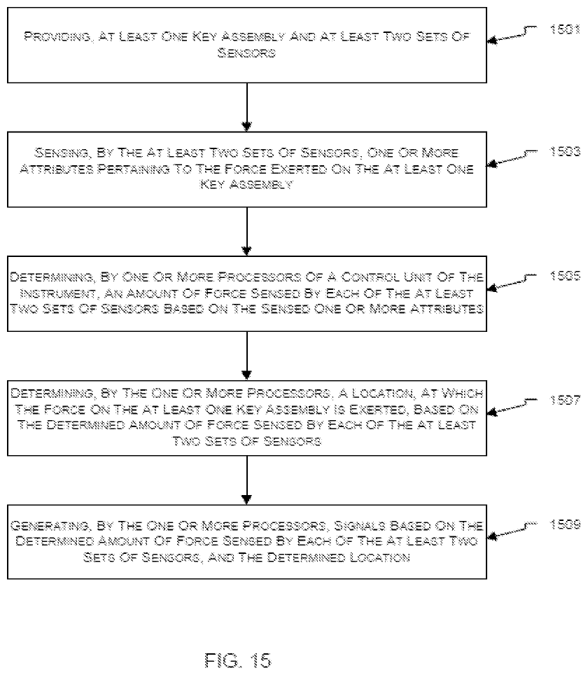

FIGS. 14A and 14B illustrate an exemplary representation of working of a key assembly of the proposed musical instrument, in accordance with an embodiment of the present disclosure. The key assembly 102 may be referred as top-down along Y-axis from one of its short edge to the other to understand details as further elaborated.

In an aspect, the proposed musical instrument may sense changes in: a) centre of pressure along an axis (say x-axis and hence termed as X_COP), b) centre of pressure along a perpendicular axis (say y-axis, hence termed as Y_COP), and c) Total pressure (P), simultaneously, applied by one finger on it while playing a musical note, as further described. Therefore, the sensing the above parameters may enable the instrument to create a 3-dimension input feature for each musical note and generated signals, which may then be used by a protocol such as Musical Instrument Digital Interface (MIDI) to control various sound synthesis techniques. In this manner, the variance in X_COP, Y_COP, and total pressure may be used to provide note shaping effects such as vibratos, pitch bending and so forth, with natural and intuitive finger motions on the key assembly of the proposed musical instrument 100.

In an embodiment, as the finger moves along Y-axis on the key-top, the uneven distribution of force may carry information of the centre of pressure in the Y direction (i.e., along the Y-axis, Y_COP). Any change in Y position of the finger for same force applied may be discerned through this technique. Similarly, as the finger moves along X-axis on the key-top, the uneven distribution of force may carry information of the centre of pressure in the X direction (i.e., along the X-axis, X_COP). Any change in X position of the finger for same force applied may be discerned through this technique. One force transducer on the ‘top’ edge and two force sensors/transducers on its ‘bottom’ edge as described above may enable detection of such changes with high sensitivity based upon nuanced gestures/movements of various fingers on various key-switches.

As shown in FIG. 14A, when a finger 1402 depresses the key assembly (using the first member 202) at a distance ‘a’ from one end of the first member 202, a plunger mechanism 204 may get compressed. In this manner, a force F may be exerted on the first member 202 is transferred to the second member 206. The first member 202 may also exert pressure on the second member 206 via bushes 208. Sensors 210 and 212 may be attached to base/bottom surface of the second member 206 on its opposite edges as they in turn press against the chassis of the instrument. The sensors 210 and 212 may sense one or more attributes pertaining to the force F.

In an exemplary embodiment, Y_COP may be determined as under.

Since the body is in equilibrium, the total forces on it are balanced and so:

F−N₁−N₂=0 (i)

where F is the total force which is of interest,

N1=Total force captured/sensed by the bottom sensors and

N2=Total force captured/sensed by the top sensors.

In an embodiment, the sensor may directly sense the forces applied on it. In some other embodiment, the sensor may sense one or more attributes such as but not limited to pressure, torque and so forth, pertaining to the force applied to it. These parameters are given as input to a control unit to determine the amount of the force applied on it.

Further, as there is no rotation of the key assembly, the moment about any point is balanced or the torque created by a performer's/user's key press at the Y_COP location along Y-axis is balanced by the torque offered by all the reaction forces (as read from each sensors). The moment balance equation about the top point of the key-switch yields the following equation (In case of two rows of sensors per key assembly)

F×Y_COP−N₁×L=0 (ii)

where L is the total length of the key assembly (more precisely, it is the distance between the top and the bottom sensors). Y_COP (shown as ‘a’ in the FIG. 9A) is the distance of the point of force application from one end of the first member of the key assembly.

Since L is known and N1 and N2 may be measured, the two unknown parameters ‘F’ and ‘Y_COP’ may be obtained using the above equations.

In a similar manner, as shown in FIG. 14B, when the first member 202 is depressed by finger 1402, load is transferred to sensors 210 and 212 on bottom of the second member 206. The first member 202 may also exert pressure on the second member 206 via the bushes 208. Force transferred may be sensed by the sensors 210 and 212 attached to bottom view of the second member 206 on its opposite edges as they in turn press against the immoveable chassis of the keyboard.

Moment balance along X-axis may be used to determine the X_COP. Considering key width of a key-switch to be ‘W’, torque created by a performer's/user's key press at X_COP is balanced by torque offered by all the reaction forces (as read from each sensor). As the total force ‘F’, width ‘W’ and the spatial placement of each of the sensors (where the normal forces occur) is known, X_COP may be determined by forming a torque balance equation (or a moment balance equation, where the clockwise moment is equated to the anti-clockwise moment).

Sometimes, since the equations for accurate measurements may involve complex balance equations (especially when too many sensors may be involved), certain approximations that correlate well to the final result may be used to simplify the computation required in real time. For example, instead of multiplication, simple additions may provide well correlated results in a particular range, or subtraction maybe used instead of division etc. All such embodiments are fully a part of the present disclosure.

In one exemplary embodiment, the control unit includes one or more microprocessors and supporting circuits (e.g., memory, interface, etc.) that implement above describes systems/methods based on executing program instructions comprising a computer program stored in a computer readable medium of the control unit.

FIG. 15 illustrates a flow diagram of a method 1500 for producing an instrumental as disclosed above, in accordance with an embodiment of the present disclosure.

In an embodiment, the disclosed method 1500 can include at step 1501, providing at least one key assembly and at least two sets of sensors are provided, and at step 1503, sensing by the at least two sets of sensors one or more attributes pertaining to the force exerted on the at least one key assembly. The method can include at step 1505, determining by one or more sensors of a control unit/controller an amount of the force exerted on the at least one key assembly based on the sensed one or more attributes, and at step 1507, determining by the one or more processors a location at which the force on the at least one key assembly is exerted, based on the determined amount of force sensed by each of the at least two sets of sensors.

The method can include at step 1509, generating, by the one or more processors signals based on the determined amount of force sensed by each of the at least two sets of sensors, and the determined location. The generated signals are associated with one or more acoustic parameters.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Invention

The present disclosure provides an improved electronic musical instrument with more nuance gestures.

The present disclosure provides a simple electronic musical instrument with a minimal number of sensors with as low as three discrete sensors per key assembly.

The present disclosure provides an improved electronic musical instrument that is economical to manufacture, and easy to capture all the finer nuances of playing an acoustic analog musical instrument.

The present disclosure provides an improved musical instrument with more continuous expressive music control to its user/performer required for producing various expressive instrumental sounds than offered by a traditional electronic Musical Instrument Digital Interface (MIDI) keyboard.

We claim:

1. A musical instrument comprising:
at least one key assembly comprising:
at least two members comprising a first member and a second member, the first member movably configured with respect to the second member along an axis to move between a pushed position in which the first member is moved towards the second member, and a raised position in which the first member is moved away from the second member; and
a plunger configured between the first member and the second member such that when a force is exerted on top surface of the first member, the plunger gets compressed to allow the first member to move from the raised position to the pushed position, and wherein removal of the force from the plunger in the compressed state enables the first member to move from the pushed position to the raised position, the force being transferred from the first member to the second member through the plunger;
at least two sets of sensors coupled to the second member at predefined positions to sense one or more attributes pertaining to the force exerted on the first member; and
a control unit operatively coupled to the at least two sets of sensors, the control unit configured to:
determine an amount of force sensed by each of the at least two sets of sensors based on the sensed one or more attributes;
determine a location, at which the force on the first member is exerted, based on the determined amount of force sensed by each of the at least two sets of sensors; and
generate signals based on the determined amount of force sensed by each of the at least two sets of sensors, and the determined location,
wherein the generated signals are associated with one or more acoustic parameters.

2. The instrument as claimed in claim 1, wherein the axis along which the first member is movably configured with respect to the second member is perpendicular to the first member and the second member.

3. The instrument as claimed in claim 1, wherein the at least two sets of sensors comprises a first set of sensors and a second set of sensors.

4. The instrument as claimed in claim 3, wherein the first set of sensors is configured to sense one or more attributes pertaining to a first amount of the force and the second set of sensors is configured to sense one or more attributes pertaining to a second amount of the force, and wherein the first amount of the force and the second amount of the force together amounts to the force exerted on the first member.

5. The instrument as claimed in claim 3, wherein the first set of sensors and the second set of sensors are connected to a bottom surface of the second member at opposite ends.

6. The instrument as claimed in claim 3, wherein the first set of sensors and the second set of sensors are connected to a top surface of the second member at opposite ends.

7. The instrument as claimed in claim 1, wherein the one or more attributes pertaining to the force, comprises at least one of a velocity at which the force is exerted, an angle at which the force is exerted, and a pressure exerted by the force.

8. The instrument as claimed in claim 1, wherein the one or more acoustic parameters comprises at least one of note, pitch bend, slide modulation, velocity, and pitch.

9. A method for building a musical instrument, the method comprising:
providing, at least one key assembly and at least two sets of sensors;
sensing, by the at least two sets of sensors, one or more attributes pertaining to a force exerted on the at least one key assembly;
determining, by one or more processors of a control unit of the musical instrument, an amount of force sensed by each of the at least two sets of sensors based on the sensed one or more attributes;
determining, by the one or more processors, a location, at which the force on the at least one key assembly is exerted, based on the determined amount of force sensed by each of the at least two sets of sensors; and
generating, by the one or more processors, signals based on the determined amount of force sensed by each of the at least two sets of sensors, and the determined location, wherein the generated signals are associated with one or more acoustic parameters.
